(19) United States
(12) Patent Application Publication
(10) Pub. No.: US 2025/0144889 A1
(43) Pub. Date: May 8, 2025

(54) Controlling Inductive Welding

(71) Applicant: The Boeing Company, Arlington, VA (US)

(72) Inventors: Travis Roy Adams, Villa Ridge, MO (US); Francis J. Samalot, Santa Clarita, CA (US); Aaron Ross Cowin, Dardenne Prairie, MO (US); Sherman Dominic D’Souza, Maryland Heights, MO (US); Kenndy San, Wentzville, MO (US); Ying Shi, Saint Louis, MO (US)

(21) Appl. No.: 18/502,707

(22) Filed: Nov. 6, 2023

(51) Int. Cl. B29C 65/32; B29C 65/00; H05B 6/10

(52) U.S. Cl. CPC B29C 65/32; B29C 66/91421; H05B 6/105

(57) ABSTRACT

Methods of controlling induction welding. An electrically conductive metal is machined into a heat sink comprising a plurality of channels extending from a first end of the heat sink to a second end of the heat sink. The plurality of channels is connected to a fluid control system comprising a number of pumps, a heater, a chiller, and a number of valves. The heat sink is positioned on top of a first composite part and clamped to a support structure underneath the first composite part. An electromagnetic field is applied to the first composite part under the heat sink to inductively weld the first composite part to a second composite part beneath the first composite part to form a thermoplastic joint. A heat control fluid is flowed through the plurality of channels to control a temperature of the first composite part during induction welding of the thermoplastic joint.

### BACKGROUND INFORMATION

### 1. Field

The present disclosure relates generally to induction welding and more specifically to controlling heat in induction welding.

### 2. Background

Heat management is an aspect of induction welding structural thermoplastic composites. Managing the heat of thermoplastic parts during the induction welding influences the quality of the completed thermoplastic weld.

Unfortunately, conventional heat sinks for induction welding are often expensive and have long lead-times. If, during product development, the standard size heat sinks are not adequate, new ones are designed and ordered. Changing geometry during development is time-consuming and undesirably expensive.

Therefore, it would be desirable to have a method and apparatus that takes into account at least some of the issues discussed above, as well as other possible issues. For example, it would be desirable to provide heat sinks that are at least one of less time consuming to produce or less expensive.

### SUMMARY

An embodiment of the present disclosure provides a method of controlling induction welding. An electrically conductive metal is machined into a heat sink and comprising a plurality of channels extending from a first end of the heat sink to a second end of the heat sink. The plurality of channels is connected to a fluid control system comprising a number of pumps, a heater, a chiller, and a number of valves. The heat sink is positioned on top of a first composite part. The heat sink is clamped to a support structure underneath the first composite part. An electromagnetic field is applied to the first composite part under the heat sink to inductively weld the first composite part to a second composite part beneath the first composite part to form a thermoplastic joint. A heat control fluid is flowed through the plurality of channels to control a temperature of the first composite part during induction welding of the thermoplastic joint.

Another embodiment of the present disclosure provides a method of controlling induction welding. A heat sink and a number of secondary heat sinks are connected to a fluid control system comprising a number of pumps, a heater, a chiller, and a number of valves. The heat sink is positioned on top of a first composite part. The number of secondary heat sinks is positioned at least one of beside or beneath the first composite part. The heat sink is clamped to a support structure beneath the first composite part. An electromagnetic field is applied to the first composite part under the heat sink to inductively weld the first composite part to the second composite part beneath the first composite part to form the thermoplastic joint. A heat control fluid is flowed through the heat sink and a number of secondary heat sinks to control a temperature of the first composite part during induction welding of the thermoplastic joint.

A further embodiment of the present disclosure provides a temperature control system for induction welding. The temperature control system comprises a heat sink formed of an electrically conductive metal having a unitary footprint of a thermoplastic joint and comprising a plurality of channels extending from a first end of the heat sink to a second end of the heat sink; a fluid control system comprising a number of pumps, a heater, a chiller, and a number of valves; and a number of secondary heat sinks. Each secondary heat sink of the number of secondary heat sinks has a length the same as the unitary footprint of the heat sink, each secondary heat sink comprises a number of channels extending through the secondary heat sink.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an isometric view of a temperature control system for induction welding in accordance with an illustrative embodiment;

FIG. 4 is an illustration of a cross-sectional view of a temperature control system for induction welding in accordance with an illustrative embodiment;

FIG. 5 is an illustration of an isometric view of a temperature control system for induction welding in accordance with an illustrative embodiment;

FIG. 6 is an illustration of a cross-sectional view of a temperature control system for induction welding in accordance with an illustrative embodiment;

FIGS. 7A and 7B are a flowchart of a method of controlling induction welding in accordance with an illustrative embodiment;

FIG. 8 is a flowchart of a method of controlling induction welding in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

The illustrative embodiments recognize and take into account that conventional induction welding heat sinks are formed of specialized ceramic materials. The conventional induction welding heat sinks have standard sizes. The illustrative embodiments recognize and take into account that some conventional heat sinks are connected in series to cover a length of a thermoplastic joint. The illustrative embodiments recognize and take into account that specialized ceramic materials are utilized to provide a desired thermal conductivity. The illustrative embodiments recognize and take into account that the specialized ceramic materials are also selected due to the specialized ceramic materials being electrically non-conductive.

The illustrative embodiments recognize and take into account that creating new heat sinks is time consuming due to material lead time and design lead time. The illustrative embodiments recognize and take into account that due to the specialized ceramic materials and engineering hours for redesign, creating new heat sinks is undesirably expensive.

The illustrative embodiments present heat sinks that are less expensive and less time consuming to create while providing an effective thermal conductivity desired for controlling the temperature of thermoplastic parts during induction welding. The illustrative embodiments present heat sinks formed of an electrically conductive material with a plurality of channels extending through each respective heat sink. Heat control fluid sent through the plurality of channels controls the effective thermal conductivity of the heat sink. The temperature of the heat control fluid is managed by a fluid control system comprising a chiller and a heater. The electrically conductive metal is more easily manufactured. As a result, a heat sink can be designed and manufactured with a footprint designed for a specific thermoplastic joint with less expense and in less time than for conventional heat sinks.

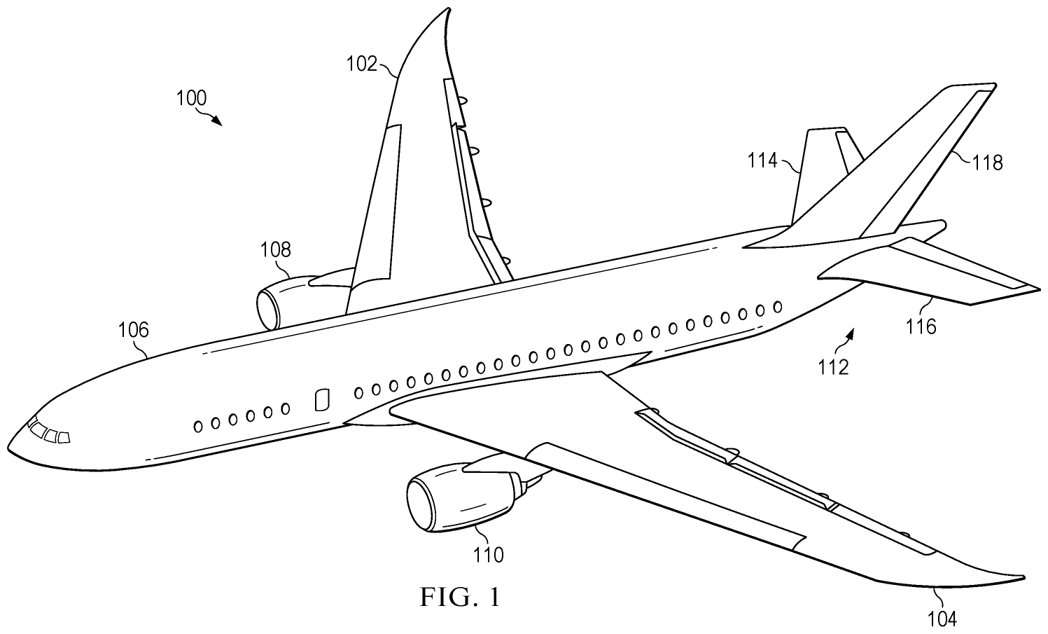

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have components that are induction welded. Aircraft 100 is an example of an aircraft that can have components that are induction welded while controlling temperature using the methods or heat sink of the illustrative examples.

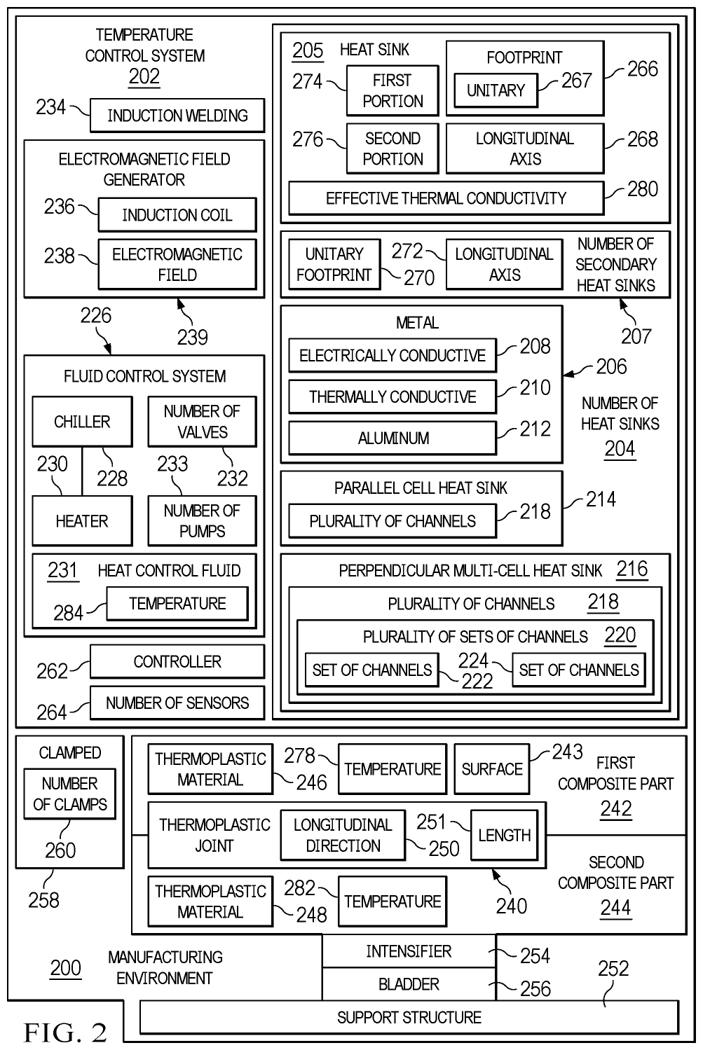

Turning now to FIG. 2, an illustration of a block diagram of a manufacturing environment is depicted in accordance with an illustrative embodiment. Induction welding 234 of first composite part 242 and second composite part 244 can be performed in manufacturing environment 200. During induction welding 234 heat generated in first composite part 242 and second composite part 244 is used to form thermoplastic joint 240. Induction coil 236 generates electromagnetic field 238. Electromagnetic field 238 is applied to first composite part 242 and second composite part 244 to form thermoplastic joint 240.

First composite part 242 comprises thermoplastic material 246. Second composite part 244 comprises thermoplastic material 248. When first composite part 242 and second composite part 244 are exposed to electromagnetic field 238, fibers of thermoplastic material 246 generate heat in response to electromagnetic field 238. Electromagnetic field 238 heats the fibers within thermoplastic material 246 and thermoplastic material 248. A portion of first composite part 242 closer to induction coil 236 is heated to a greater extent than at thermoplastic joint 240. Heat sink 205 absorbs and dissipates the heat from first composite part 242.

First composite part 242 comprises thermoplastic material 246 reinforced with electrically conductive fibers. Second composite part 244 comprises thermoplastic material 248 reinforced with electrically conductive fibers. Thermoplastic material 246 and thermoplastic material 248 comprise any desirable type of thermoplastic. In an illustrative example, thermoplastic material 246 and thermoplastic material 248 are selected from the group consisting of semi-crystalline thermoplastics and amorphous thermoplastics. The semi-crystalline thermoplastics can include polyphenylene sulfide (PPS), polyetheretherketone (PEEK), polyetherketoneketone (PEKK) and polyarylketone (PAEK). The amorphous thermoplastics may include polyetherimide (PEI). The semi-crystalline thermoplastic have high consolidation temperatures with good mechanical properties relative to conventional thermoplastics. The amorphous thermoplastics exhibit a gradual softening on heating with the material having good elongation, toughness and impact resistance properties relative to conventional thermoplastics. Semi-crystalline thermoplastics contain areas of tightly folded chains (crystallites) that are connected together and exhibit a sharp melting point on heating when the crystalline regions start dissolving. As the polymer approaches its melting point, the crystalline lattice breaks down and the molecules are free to rotate and translate.

During slow cooling, the semi-crystalline thermoplastic nucleate and grow crystalline regions which provides increased strength, stiffness, solvent resistance and temperature stability relative to an amorphous structure. If a semicrystalline thermoplastic is cooled too quickly it may form an amorphous structure. As a result, controlling the cooling of thermoplastic material 246 and thermoplastic material 248 during induction welding 234 is important to control material properties of the resulting composite part.

Temperature control system 202 is used to control temperature 278 of first composite part 242 during induction welding 234. In some illustrative examples, temperature control system 202 is used to control a temperature 282 of second composite part 244 during induction welding 234.

Temperature control system 202 for induction welding 234 comprises number of heat sinks 204. In some illustrative examples, number of heat sinks 204 comprises a primary heat sink, heat sink 205. In some illustrative examples, number of heat sinks 204 further comprises number of secondary heat sinks 207. In some illustrative examples, number of secondary heat sinks 207 is optional.

Number of heat sinks 204 can be manufactured in any desirable fashion. In some illustrative examples, a heat sink of number of heat sinks 204 can be additively manufactured, broached, or cast and machined. A heat sink of number of heat sinks 204 could be manufactured as two halves and then joined via mechanical means, such as a seal between two halves and fastened, or could be welded together.

Each of number of heat sinks 204 is formed of metal 206. In some illustrative examples, metal 206 is selected based on at least one of the machinability, structural strength, or cost. In some illustrative examples, metal 206 is selected based on how electrically conductive 208 and how thermally conductive 210 metal 206 is. In some illustrative examples, metal 206 is selected such that metal 206 is cooled faster due to being thermally conductive 210 and actively cooled than heat can be generated due to metal 206 being electrically conductive 208 and exposed to electromagnetic field 238. Metal 206 is selected so that number of heat sinks 204 is able to be cooled faster than heat can be generated by the presence of electromagnetic field 238.

In some illustrative examples, metal 206 can be aluminum 212. In some illustrative examples, heat sink 205 is formed of aluminum 212. In some illustrative examples, heat sink 205 and number of secondary heat sinks 207 are formed of aluminum 212. In some illustrative examples, number of secondary heat sinks 207 is formed by machining electrically conductive 208 metal 206 into a secondary heat sink having unitary footprint 270 with length 251 of thermoplastic joint 240.

Metal 206 is less expensive than specialized ceramic materials used in conventional heat sinks for induction welding 234. Metal 206 is more easily machined and processed than specialized ceramic materials used in conventional heat sinks for induction welding 234.

Each of number of heat sinks 204 is formed with plurality of channels 218. Plurality of channels 218 is laid out in either a parallel or perpendicular arrangement relative to longitudinal direction 250 of thermoplastic joint 240. When plurality of channels 218 of a heat sink is arranged parallel to thermoplastic joint 240, plurality of channels 218 is arranged parallel to a longitudinal direction of the respective heat sink. When plurality of channels 218 of a respective heat sink is arranged parallel to thermoplastic joint 240, the respective heat sink is referred to as parallel cell heat sink 214.

When plurality of channels 218 is laid out perpendicular to thermoplastic joint 240, plurality of channels 218 is laid out perpendicular to a longitudinal direction of the respective heat sink. When plurality of channels 218 of a respective heat sink is arranged perpendicular to thermoplastic joint 240, the respective heat sink is a perpendicular heat sink. In some illustrative examples, plurality of channels 218 of a respective heat sink is arranged perpendicular to thermoplastic joint 240, and referred to as perpendicular multi-cell heat sink 216. Although perpendicular multi-cell heat sink 216 is depicted, in some illustrative examples, plurality of channels 218 perpendicular to thermoplastic joint 240 could instead be arranged in a single set of channels. In this illustrative example, the single set of channels would be operated with a same flow of heat control fluid 231 across all of longitudinal direction 250 of thermoplastic joint 240.

In some illustrative examples, the primary heat sink, heat sink 205, is formed of electrically conductive 208 metal 206 having unitary 267 footprint 266 of thermoplastic joint 240 and comprising plurality of channels 218 extending from a first end of heat sink 205 to a second end of heat sink 205. Heat sink 205 can be additively manufactured, broached, or cast and machined.

Heat sink 205 can be manufactured as two halves and then joined via mechanical means, such as a seal between two halves and fastened, or could be welded together. For example, heat sink 205 can comprise first portion 274 and second portion 276 joined together. In some illustrative examples, first portion 274 and second portion 276 of heat sink 205 are joined, each of first portion 274 and second portion 276 having unitary 267 footprint 266 of thermoplastic joint 240. In some illustrative examples, first portion 274 can be considered a top of heat sink 205 and second portion 276 can be considered a bottom of heat sink 205.

Heat sink 205 is configured to control temperature 278 of first composite part 242 during induction welding 234. Heat sink 205 can be redesigned and manufactured more quickly than conventional heat sinks due to being made from metal 206 and having the ability to adjust effective thermal conductivity 280 of heat sink 205.

Plurality of channels 218 of heat sink 205 are connected to fluid control system 226 to control effective thermal conductivity 280 of heat sink 205. Fluid control system 226 comprises number of pumps 233, heater 230, chiller 228, and number of valves 232. Fluid control system 226 sends heat control fluid 231 through plurality of channels 218 to control temperature 282 of first composite part 242 during induction welding 234 of thermoplastic joint 240.

At least one of volume and temperature 284 of heat control fluid 231 can be controlled to modify effective thermal conductivity 280 of heat sink 205. Temperature 284 of heat control fluid 231 can be changed using at least one of chiller 228 or heater 230.

When present, number of secondary heat sinks 207 is also connected to fluid control system 226. Flowing heat control fluid 231 through heat sink 205 and number of secondary heat sinks 207 comprises independently controlling at least one of a volume or temperature 284 of heat control fluid 231 flowing through each of heat sink 205 and number of secondary heat sinks 207. Number of pumps 233 and number of valves 232 can be used to independently control heat control fluid 231 supplied to each heat sink of number of heat sinks 204. Number of pumps 233 and number of valves 232 can be used to independently control heat control fluid 231 supplied to each set of channels in a respective heat sink with independently controlled plurality of sets of channels 220.

Each of number of secondary heat sinks 207 can be manufactured based on a desired location for the respective secondary heat sink relative to first composite part 242 and second composite part 244. In some illustrative examples, each secondary heat sink of the number of secondary heat sinks 207 has a length the same as unitary 267 footprint 266 of heat sink 205. Each secondary heat sink comprises a respective number of channels extending through the respective secondary heat sink.

In some illustrative examples, number of secondary heat sinks 207 has a smaller width than unitary 267 footprint 266. In some illustrative examples, number of secondary heat sinks 207 comprises a secondary heat sink to the side of thermoplastic joint 240 and configured to control the temperature of at least one of first composite part 242 or second composite part 244.

Plurality of channels 218 in each heat sink of number of heat sinks 204 is independently designed. In some illustrative examples, number of heat sinks 204 is a mix of perpendicular heat sinks and parallel multi-cell heat sinks. In some illustrative examples, heat sink 205 has a different direction of plurality of channels 218 than at least one secondary heat sink of number of secondary heat sinks 207. In some illustrative examples, plurality of channels 218 in heat sink 205 run perpendicular to longitudinal axis 268 of heat sink 205, and the number of channels in each secondary heat sink runs parallel to a longitudinal axis of the respective secondary heat sink.

In some illustrative examples, plurality of channels 218 is parallel to longitudinal axis 268 of heat sink 205. When plurality of channels 218 in heat sink 205 is parallel, heat sink 205 can be referred to as parallel cell heat sink 214. In some illustrative examples, plurality of channels 218 is perpendicular to longitudinal axis 268 of heat sink 205. When plurality of channels 218 in heat sink is perpendicular and divided into independently controllable plurality of sets of channels 220, heat sink 205 can be referred to as perpendicular multi-cell heat sink 216.

Footprint 266 is designed based on thermoplastic joint 240. In some illustrative examples, footprint 266 is configured to cover surface 243 of first composite part 242 exposed to electromagnetic field 238. In some illustrative examples, footprint 266 is configured such that surface 243 of first composite part 242 exposed to electromagnetic field 238 is covered by a minimum quantity of heat sinks.

Temperature control system 202 can further include number of sensors 264 in electronic communication with controller 262. Number of sensors 264 is configured to detect or sense conditions of at least one of first composite part 242, second composite part 244, or heat control fluid 231 during the induction welding 234 in order to provide real-time feedback to controller 262. In some illustrative examples, number of sensors 264 comprises temperature sensors configured to detect a temperature of at least one of first composite part 242, second composite part 244, or heat control fluid 231.

In some illustrative examples, number of sensors 264 comprises electromagnetic field sensors configured to detect a strength of electromagnetic field 238 generated by the induction coil 236. In some illustrative examples, number of sensors 264 can be used by controller 262 in feedback control of induction coil 236.

In some illustrative examples, heat sink 205 is designed and manufactured based on a designed size and shape for thermoplastic joint 240. In some illustrative examples, heat sink 205 is manufactured for use with thermoplastic joint 240. In some illustrative examples, a heat sink, such as heat sink 205, is designed such that a single heat sink can be used to cool surface 243 of first composite part 242. In some illustrative examples, heat sinks are designed such that a small quantity of heat sinks can be used to cool surface 243 of first composite part 242.

Heat sink 205 is clamped 258 to support structure 252 beneath first composite part 242. Heat sink 205 can be secured to support structure 252 using number of clamps 260 or any other desirable securing mechanism. A compressive force is applied to first composite part 242 and second composite part 244 during induction welding 234 by intensifier 254 and bladder 256. Heat sink 205 is sufficiently strong to withstand the compressive force applied. As a result, heat sink 205 acts as a clamp for thermoplastic joint 240. Heat sink 205 is structural to withstand the compression and flexural loading it will see. Heat sink 205 applies reactive force to thermoplastic joint 240.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although intensifier 254 and bladder 256 are depicted to apply pressure to thermoplastic joint 240 during induction welding 234, in other illustrative examples at least one of intensifier 254 or bladder 256 may not be present. In some illustrative examples, a pressure applicator other than bladder 256 can be used.

Although plurality of channels 218 is described as parallel and perpendicular, plurality of channels 218, plurality of channels 218 need not be perfectly parallel or perpendicular. Plurality of channels 218 can run transverse to a longitudinal direction of at least one of a respective heat sink or the thermoplastic joint. Plurality of channels 218 can run along a longitudinal direction of at least one of a respective heat sink or the thermoplastic joint. In some illustrative examples, plurality of channels 218 are about or approximately either parallel or perpendicular. Additionally, deviations or variations, such as manufacturing or measurement variations and tolerances can occur in amounts that do not preclude the effect that the characteristic was intended to provide.

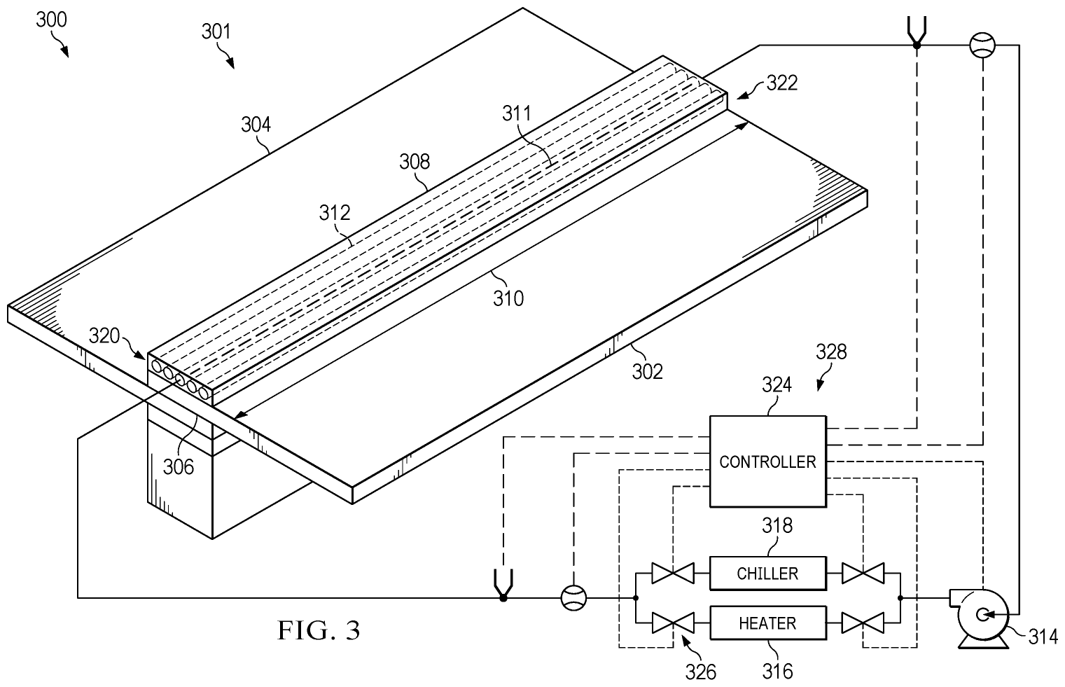

Turning now to FIG. 3, an illustration of an isometric view of a temperature control system for induction welding is depicted in accordance with an illustrative embodiment. Temperature control system 301 is visible in view 300. In view 300, first composite part 302 is being joined to second composite part 304 to form thermoplastic joint 306 at the intersection between first composite part 302 and second composite part 304.

Temperature control system 301 comprises heat sink 308 formed of an electrically conductive metal. Heat sink 308 has a unitary footprint of thermoplastic joint 306. As depicted, heat sink 308 has a unitary footprint with length 310 of thermoplastic joint 306. Heat sink 308 comprises plurality of channels 312 extending from first end 320 of heat sink 308 to second end 322 of heat sink 308. In this illustrative example, plurality of channels 312 are parallel to length 310 of thermoplastic joint 306. In this illustrative example, plurality of channels 312 are parallel to longitudinal axis 311 of heat sink 308.

Fluid control system 328 supplies heat control fluid (not depicted) to plurality of channels 312 to actively cool heat sink 308 and first composite part 302. Fluid control system 328 comprises number of pumps 314, heater 316, chiller 318, and number of valves 326. Controller 324 uses closed loop feedback to maintain a desired temperature on first composite part 302. Controller 324 can control the utilization of heater 316 and chiller 318 to modify a temperature of the heat control fluid supplied to heat sink 308. Controller 324 of fluid control system 328 provides the ability to use a closed loop feedback to maintain a desired temperature on first composite part 302 while being able to adjust the effective thermal conductivity of heat sink 308.

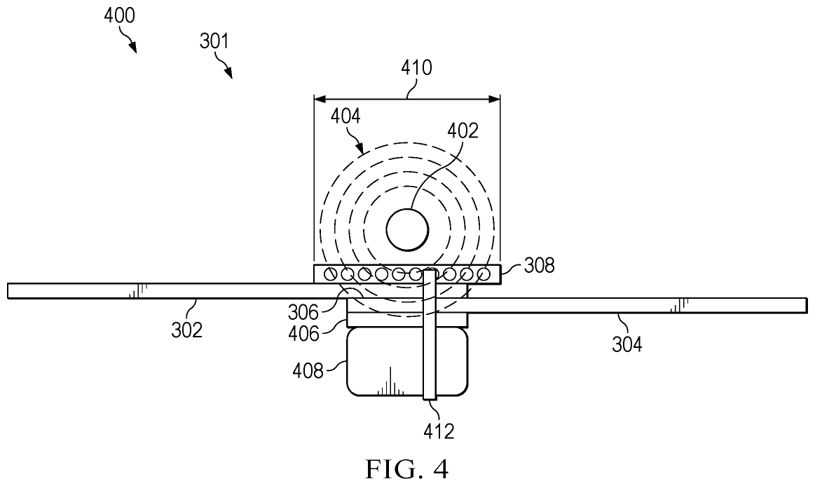

Turning now to FIG. 4, an illustration of a cross-sectional view of a temperature control system for induction welding is depicted in accordance with an illustrative embodiment. In view 400, induction coil 402 is illustrated with temperature control system 301. In view 400, induction coil 402 generates electromagnetic field 404 that is applied to first composite part 302 and second composite part 304. Electromagnetic field 404 is applied to a surface of first composite part 302 beneath heat sink 308. Heat sink 308 has a footprint configured to cover the surface of first composite part 302 exposed to electromagnetic field 404. Width 410 of heat sink 308 covers the width of thermoplastic joint 306.

A compressive force is applied to first composite part 302 and second composite part 304 during inductive welding by intensifier 406 and bladder 408. Heat sink 308 is sufficiently strong to withstand the compressive force applied. As a result, heat sink 308 acts as a clamp for thermoplastic joint 306. Heat sink 308 is structural to withstand the compression and flexural loading it will see. Heat sink 308 applies reactive force to thermoplastic joint 306.

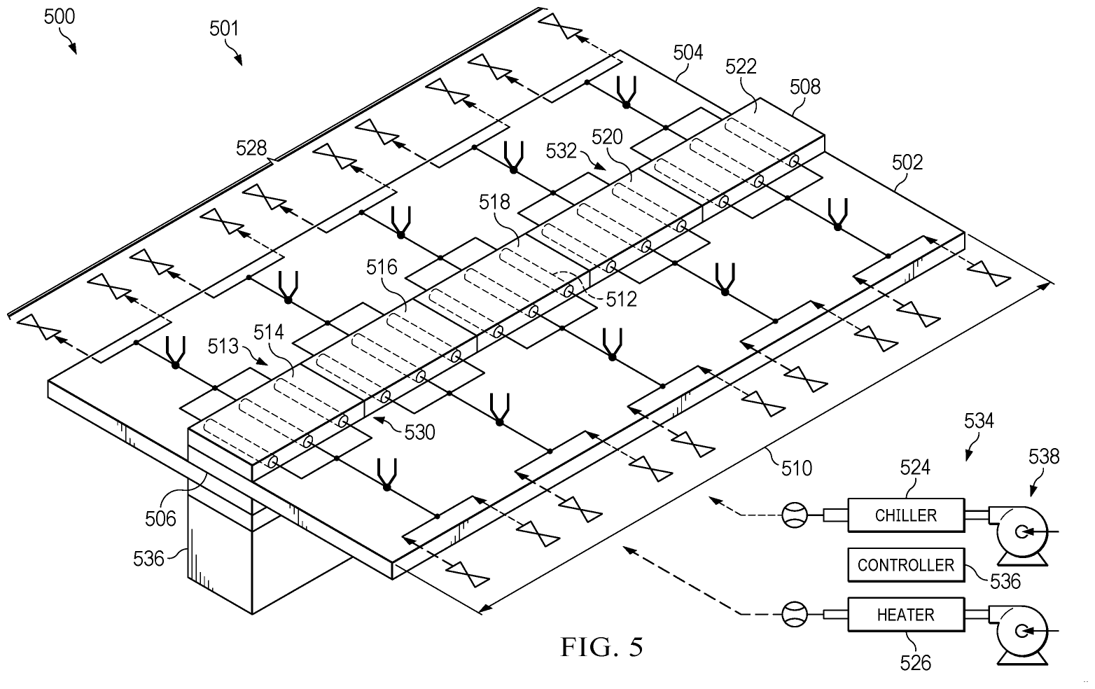

Turning now to FIG. 5, an illustration of an isometric view of a temperature control system for induction welding is depicted in accordance with an illustrative embodiment. Temperature control system 501 is visible in view 500. In view 500, first composite part 502 is being joined to second composite part 504 to form thermoplastic joint 506 at the intersection between first composite part 502 and second composite part 504.

Temperature control system 501 comprises heat sink 508 formed of an electrically conductive metal. In some illustrative examples, the footprint of heat sink 508 is configured to cover a surface of first composite part 502 exposed to an electromagnetic field.

Heat sink 508 has a unitary footprint of thermoplastic joint 506. As depicted, heat sink 508 has a unitary footprint with length 510 of thermoplastic joint 506. Heat sink 508 comprises plurality of channels 512 extending from first end 530 of heat sink 308 to second end 532 of heat sink 308. In this illustrative example, plurality of channels 512 are perpendicular to length 510 of thermoplastic joint 506. In this illustrative example, plurality of channels 512 are perpendicular to a longitudinal axis of heat sink 508.

Plurality of channels 512 runs perpendicular to thermoplastic joint 506 and is separated into plurality of sets of channels 513. Plurality of sets of channels 513 comprises set of channels 514, set of channels 516, set of channels 518, set of channels 520, and set of channels 522. Flow of the heat control fluid to each set of plurality of sets of channels 513 of plurality of channels 512 is independently adjusted. Temperature of portions of first composite part 502 along a length of thermoplastic joint 506 are independently controlled. For instance, a portion of first composite part 502 beneath set of channels 514 is independently controlled relative to each other set of channels. For example, a portion of first composite part 502 beneath set of channels 514 is independently controlled relative to a portion of first composite part 502 beneath set of channels 516.

Fluid control system 534 supplies heat control fluid (not depicted) to plurality of channels 512 to actively cool heat sink 508 and first composite part 502. Fluid control system 534 comprises number of pumps 538, heater 526, chiller 524, and a number of valves 528. Controller 536 uses closed loop feedback to maintain a desired temperature on first composite part 502. Controller 536 can control the utilization of heater 526 and chiller 524 to modify a temperature of the fluid supplied to heat sink 508.

Temperatures of the heat control fluid (not depicted) in each set of the plurality of sets of channels is independently controlled to independently control temperature of portions of first composite part 502 along the length of thermoplastic joint 506. Controller 536 of fluid control system 534 provides the ability to use a closed loop feedback to maintain a desired temperature on first composite part 502 while being able to adjust the effective thermal conductivity of heat sink 508.

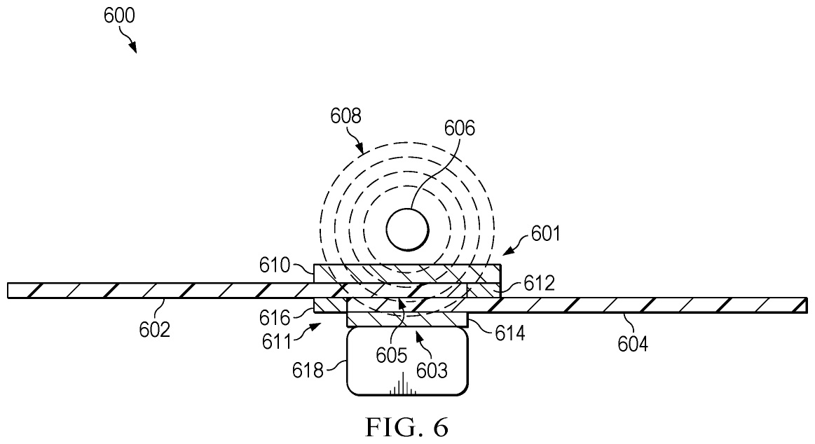

Turning now to FIG. 6, an illustration of a cross-sectional view of a temperature control system for induction welding is depicted in accordance with an illustrative embodiment. In view 600, the plurality of channels in heat sink 610 are not depicted. Heat sink 610 can comprise a plurality of channels extending either perpendicular or parallel to the longitudinal direction of thermoplastic joint 605 between first composite part 602 and second composite part 604. In view 600, induction coil 606 is positioned over first composite part 602 and applies electromagnetic field 608 to a portion of first composite part 602 beneath heat sink 610. In some illustrative examples, the footprint of heat sink 610 is configured to cover a surface of first composite part 602 exposed to electromagnetic field 608. In view 600 number of secondary heat sinks 611 is present in contact with at least one of first composite part 602 or second composite part 604. Number of secondary heat sinks 611 comprises secondary heat sink 612 in contact with a top surface of second composite part 604 and beside first composite part 602. Secondary heat sink 612 is positioned beside thermoplastic joint 605. Secondary heat sink 616 is in contact with a bottom surface of first composite part 602 and beside second composite part 604. Secondary heat sink 616 is positioned beside thermoplastic joint 605. Secondary heat sink 614 is positioned between bladder 618 and second composite part 604.

During operation of heat sink 610 and number of secondary heat sinks 611, the effective thermal conductivity of each respective heat sink can be adjusted by supplying heat control fluid to the respective heat sink. Each respective heat sink of heat sink 610 and number of secondary heat sinks can have either a single zone of channels running parallel with the weld-line or channels positioned perpendicular to the weld-line. In some illustrative examples, when the channels are perpendicular to the weld-line, the channels can be divided into discrete zones along the length of the weld-line.

FIG. 6 depicts temperature control system 601 for induction welding. Temperature control system 601 comprises a primary heat sink, heat sink 610, formed of an electrically conductive metal having a unitary footprint of thermoplastic joint 605 and comprising a plurality of channels (not depicted) extending from a first end of heat sink 610 to a second end of heat sink 610. When the plurality of channels are parallel to thermoplastic joint 605, the first end and the second end are on opposite ends of thermoplastic joint 605 into and out of the page. Temperature control system 601 comprises a fluid control system (not depicted) comprising a number of pumps, a heater, a chiller, and a number of valves. Temperature control system 601 comprises number of secondary heat sinks 611. In some illustrative examples, each secondary heat sink of the number of secondary heat sinks 611 has a length the same as the unitary footprint of the primary heat sink, each secondary heat sink comprising a number of channels extending through the secondary heat sink. As depicted, number of secondary heat sinks 611 have a smaller width than the unitary footprint.

In some illustrative examples, heat sink 610 and number of secondary heat sinks 611 are formed of aluminum.

The plurality of channels in each of heat sink 610 and number of secondary heat sinks 611 can be either of parallel or perpendicular to their respective longitudinal axes. In some illustrative examples, the plurality of channels in heat sink 610 run perpendicular to a longitudinal axis of heat sink 610, and wherein the number of channels in each secondary heat sink runs parallel to a longitudinal axis of the secondary heat sink. In some illustrative examples, the plurality of channels in heat sink 610 are parallel to a longitudinal axis of heat sink 610. In some illustrative examples, the plurality of channels in heat sink 610 are perpendicular to a longitudinal axis of heat sink 610.

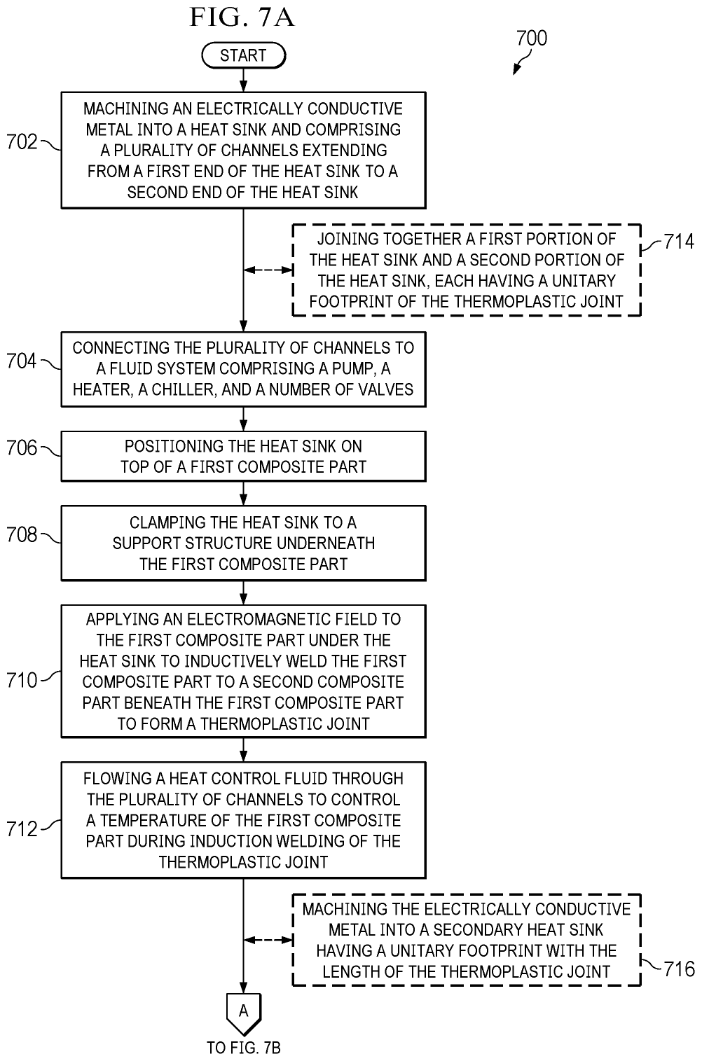

Turning now to FIGS. 7A and 7B, a flowchart of a method of controlling induction welding is depicted in accordance with an illustrative embodiment. Method 700 can be performed to form a composite component of aircraft 100 of FIG. 1. Method 700 can be performed using number of heat sinks 204 of FIG. 2. Method 700 can be performed using temperature control system 301 of FIGS. 3 and 4. Method 700 can be performed using temperature control system 501 of FIG. 5. Method 700 can be performed using temperature control system 601 of FIG. 6.

Method 700 machines an electrically conductive metal into a heat sink and comprising a plurality of channels extending from a first end of the heat sink to a second end of the heat sink (operation 702). Method 700 connects the plurality of channels to a fluid control system comprising a number of pumps, a heater, a chiller, and a number of valves (operation 704). Method 700 positions the heat sink on top of a first composite part (operation 706). Method 700 clamps the heat sink to a support structure underneath the first composite part (operation 708). Method 700 applies an electromagnetic field to the first composite part under the heat sink to inductively weld the first composite part to a second composite part beneath the first composite part to form a thermoplastic joint (operation 710). Method 700 flows a heat control fluid through the plurality of channels to control a temperature of the first composite part during induction welding of the thermoplastic joint (operation 712). Afterwards, method 700 terminates.

In some illustrative examples, the heat sink can be manufactured in multiple portions and joined together later. In some illustrative examples, the heat sink can be manufactured as a top portion and bottom portion. In some illustrative examples, method 700 joins together a first portion of the heat sink and a second portion of the heat sink, each having a unitary footprint of the thermoplastic joint (operation 714).

In some illustrative examples, method 700 machines the electrically conductive metal into a secondary heat sink having a unitary footprint with the length of the thermoplastic joint (operation 716).

In some illustrative examples, the plurality of channels following a longitudinal direction of the thermoplastic joint and the plurality of channels is separated into a plurality of sets of channels (operation 718). In some illustrative examples, each set of the plurality of sets of channels comprises an independently controllable cell of a multi-cell heat sink. In some illustrative examples, method 700 individually adjusts a flow of the heat control fluid to each set of the plurality of sets of channels to independently control temperature of portions the first composite part along a length the thermoplastic joint (operation 720). In some illustrative examples, method 700 independently controls temperatures of the heat control fluid in each set of the plurality of sets of channels to independently control temperature of portions of the first composite part along the length of the thermoplastic joint (operation 722).

In some illustrative examples, the plurality of channels runs parallel to the thermoplastic joint (operation 724). When the plurality of channels run parallel to the thermoplastic joint, the heat sink may be referred to as a parallel cell heat sink. In some illustrative examples, when the plurality of channels run parallel to the thermoplastic joint, the heat sink comprises a single cell.

In some illustrative examples, flowing the heat control fluid through the plurality of channels further comprises: controlling a temperature of the heat control fluid using both the heater and the chiller (operation 726). In some illustrative examples, using a heater and a chiller can provide more precise control over the temperature of the heat control fluid and, as a result, more precise control over an effective thermal conductivity of the heat sink.

In some illustrative examples, a number of secondary heat sinks are positioned relative to the thermoplastic joint to be formed. In some illustrative examples, a number of secondary heat sinks are positioned at least one of to the side of or beneath a location of an intended thermoplastic joint. In some illustrative examples, method 700 actively controls a temperature of the second composite part by flowing the heat control fluid through a secondary heat sink beside the first composite part and on top of the second composite part (operation 728). In some illustrative examples, method 700 actively controls a temperature of the first composite part by flowing the heat control fluid through a secondary heat sink beside the second composite part and beneath the first composite part (operation 730).

In some illustrative examples, method 700 positions an electromagnetic field generator relative to the first composite part such that the unitary footprint of the heat sink covers an area of the first composite part exposed to the electromagnetic field (operation 732). In some illustrative examples, the heat sink is able to control a temperature of the portion of first composite part heated by the electromagnetic field.

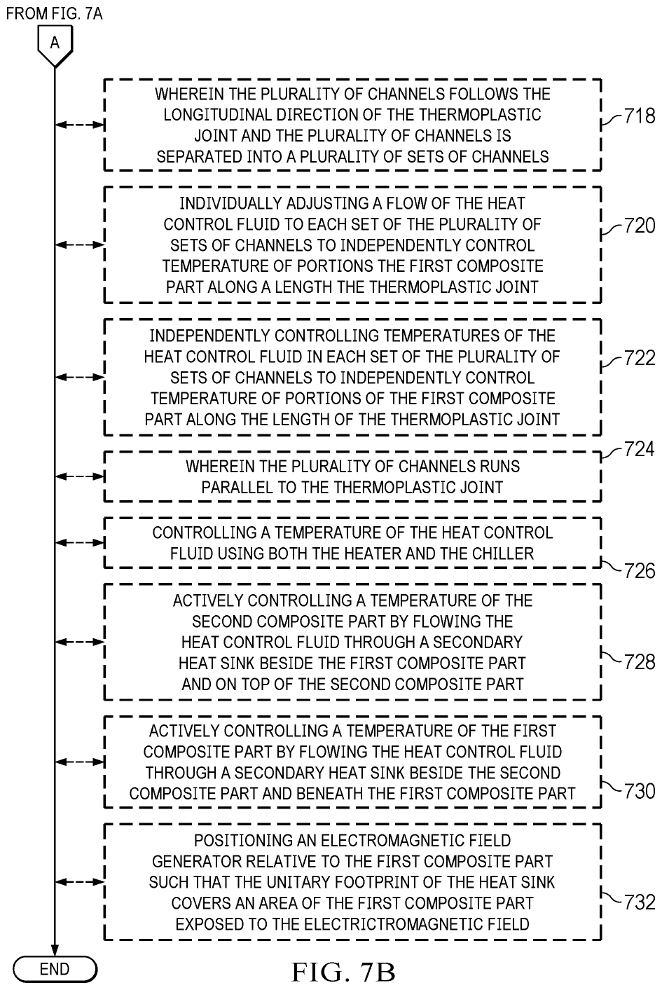

Turning now to FIG. 8, a flowchart of a method of controlling induction welding is depicted in accordance with an illustrative embodiment. Method 800 can be performed to form a composite component of aircraft 100 of FIG. 1. Method 800 can be performed using number of heat sinks 204 of FIG. 2. Method 800 can be performed using temperature control system 301 of FIGS. 3 and 4. Method 800 can be performed using temperature control system 501 of FIG. 5. Method 800 can be performed using temperature control system 601 of FIG. 6.

Method 800 connects a heat sink and a number of secondary heat sinks to a fluid control system comprising a number of pumps, a heater, a chiller, and a number of valves (operation 802). The fluid control system enables temperature control of the heat control fluid supplied to the heat sink and the number of secondary heat sinks. Method 800 positions the heat sink on top of a first composite part (operation 804). In some illustrative examples, the heat sink has a plurality of channels running perpendicular to the longitudinal direction of the heat sink. In some illustrative examples, the heat sink has a plurality of channels running parallel to the longitudinal direction of the heat sink. In some illustrative examples, the heat sink has a unitary footprint having a same length as a joint to be created between the first composite part and a second composite part. Method 800 positions the number of secondary heat sinks at least one of beside or beneath the first composite part (operation 806).

Method 800 clamps the heat sink to a support structure beneath the first composite part (operation 808). In some illustrative examples, a compressive force is applied to the first composite part and a second composite part during inductive welding. The heat sink is sufficiently strong to withstand the compressive force applied. In some illustrative examples, the heat sink acts as a clamp for the thermoplastic joint. The heat sink is structural to withstand the compression and flexural loading it will see. In some illustrative examples, the heat sink applies reactive force to the thermoplastic joint.

Method 800 applies an electromagnetic field to the first composite part under the heat sink to inductively weld the first composite part to the second composite part beneath the first composite part to form the thermoplastic joint (operation 810). Method 800 flows a heat control fluid through the heat sink and a number of secondary heat sinks to control a temperature of the first composite part during induction welding of the thermoplastic joint (operation 812). Afterwards, method 800 terminates.

In some illustrative examples, method 800 receives dimensions of the thermoplastic joint (operation 814). In some illustrative examples, method 800 machines aluminum into the heat sink having the unitary footprint with a length equivalent to a length of the thermoplastic joint using the dimensions of the thermoplastic joint (operation 816).

In some illustrative examples, method 800 the heat sink having a unitary footprint the same as a thermoplastic joint to be formed between the first composite part and a second composite part (operation 818). In some illustrative examples, flowing the heat control fluid through the heat sink and a number of secondary heat sinks comprises independently controlling at least one of a volume or a temperature of the heat control fluid flowing through each of the heat sink and the number of secondary heat sinks (operation 820).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 714 through operation 734 may be optional. As another example, operation 814 through operation 820 may be optional.

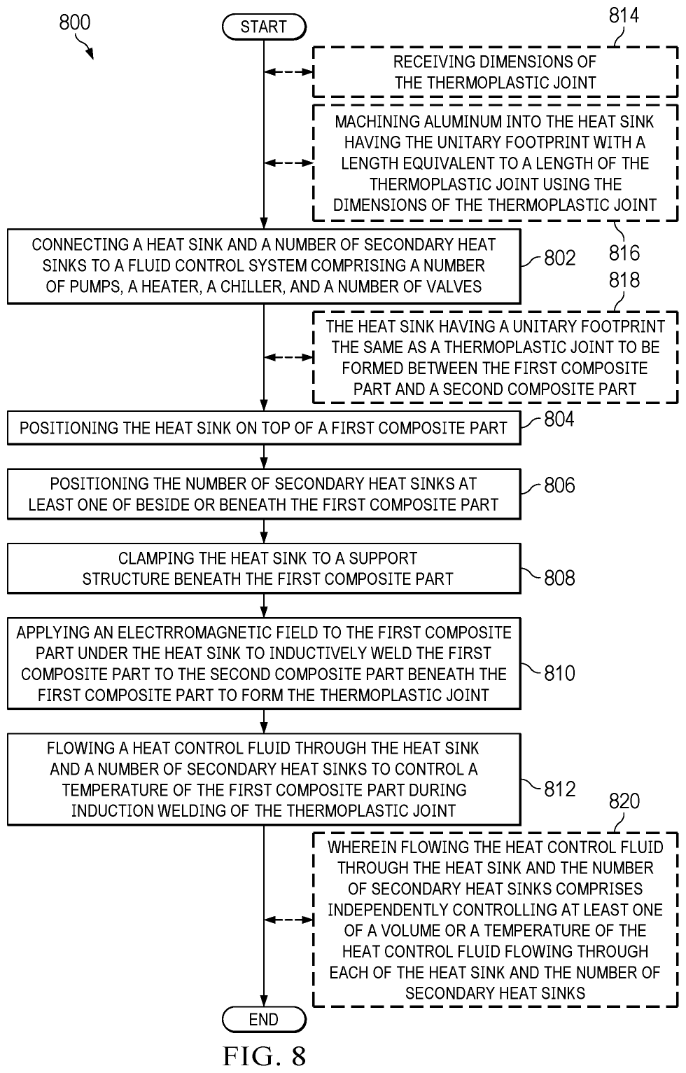

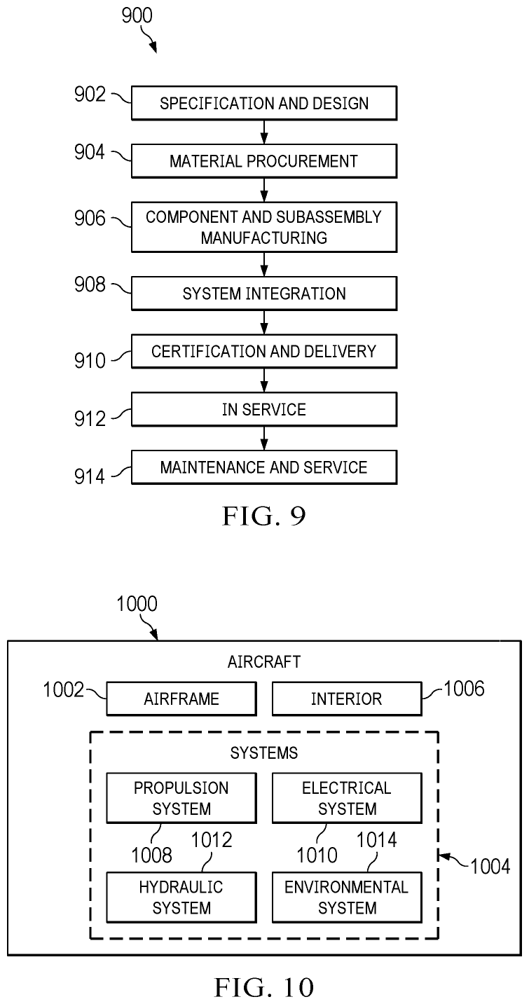

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples present methods of making and using a number of heat sinks with active cooling channels. In the illustrative examples, a direction of fluid flow could be horizontal or parallel to the weld direction. The direction of fluid flow could be serpentine or deviate. The active cooling channels can have any desirable size, shape, and distribution. The illustrative examples can vary at least one of the volumetric flow rate or the fluid temperature. The active cooling channels can have a multi-cell arrangement or horizontal in one location and parallel in another direction to provide auxiliary heat sinks.

The illustrative examples facilitate active heat management. The illustrative examples are easier and cheaper to fabricate custom heat sinks than conventional heat sinks. The illustrative examples utilize cheaper base materials than traditional materials.

In some illustrative examples, the fluid can be a phase change fluid. Using tailorable, active, closed-loop heat sinks, the illustrative examples can adjust the effective thermal conductivity of the system without having to redesign the hardware. Additionally, due to the active nature of the heat sinks of the illustrative examples, cheaper and less thermally conductive materials can be used rather than passive, highly thermally conductive material properties. The illustrative examples can use closed loop feedback to maintain a desired temperature on a part while being able to adjust the effective thermal conductivity.

Manufacturing heat sinks from metals can be less time consuming than manufacturing ceramics. As a result, changing geometry during development can be less time-consuming and less expensive using the metal heat sinks of the illustrative examples.

Using tailorable, active, closed-loop heat sinks, the effective thermal conductivity of the system can be adjusted without having to redesign hardware. Because of their active nature, cheaper materials can be used for the number of heat sinks that do not require passive, highly thermally conductive material properties. The heat sinks of the illustrative examples are adjustable and active, unlike conventional passive static systems.

The illustrative examples have the ability to use a closed loop feedback to maintain a desired temperature on a part while being able to adjust the effective thermal conductivity. There are two forms the plurality of channels in the heat sink in the heat management system can take. The first is a single zone running parallel with the weld-line, and the second is the use of discrete zones down the length of the weld-line.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of controlling induction welding comprising:
machining an electrically conductive metal into a heat sink and comprising a plurality of channels extending from a first end of the heat sink to a second end of the heat sink;
connecting the plurality of channels to a fluid control system comprising a number of pumps, a heater, a chiller, and a number of valves;
positioning the heat sink on top of a first composite part;
clamping the heat sink to a support structure underneath the first composite part;
applying an electromagnetic field to the first composite part under the heat sink to inductively weld the first composite part to a second composite part beneath the first composite part to form a thermoplastic joint; and
flowing a heat control fluid through the plurality of channels to control a temperature of the first composite part during induction welding of the thermoplastic joint.

2. The method of claim 1 further comprising:
joining together a first portion of the heat sink and a second portion of the heat sink, each having a unitary footprint of the thermoplastic joint.

3. The method of claim 2 further comprising:
machining the electrically conductive metal into a secondary heat sink having a unitary footprint with a length of the thermoplastic joint.

4. The method of claim 1, wherein the plurality of channels runs perpendicular to the thermoplastic joint and the plurality of channels is separated into a plurality of sets of channels, the method further comprising:
individually adjusting a flow of the heat control fluid to each set of the plurality of sets of channels to independently control temperature of portions the first composite part along a length the thermoplastic joint.

5. The method of claim 4 further comprising:
independently controlling temperatures of the heat control fluid in each set of the plurality of sets of channels to independently control temperature of portions of the first composite part along the length of the thermoplastic joint.

6. The method of claim 1, wherein the plurality of channels runs parallel to the thermoplastic joint.

7. The method of claim 1, wherein flowing the heat control fluid through the plurality of channels further comprises:
controlling a temperature of the heat control fluid using both the heater and the chiller.

8. The method of claim 1 further comprising:
actively controlling a temperature of the second composite part by flowing the heat control fluid through a secondary heat sink beside the first composite part and on top of the second composite part.

9. The method of claim 1 further comprising:
actively controlling the temperature of the first composite part by flowing the heat control fluid through a secondary heat sink beside the second composite part and beneath the first composite part.

10. The method of claim 1 further comprising:
positioning an electromagnetic field generator relative to the first composite part such that a unitary footprint of the heat sink covers an area of the first composite part exposed to the electromagnetic field.

11. A method of controlling induction welding comprising:
connecting a heat sink and a number of secondary heat sinks to a fluid control system comprising a number of pumps, a heater, a chiller, and a number of valves;
positioning the heat sink on top of a first composite part;
positioning the number of secondary heat sinks at least one of beside or beneath the first composite part;
clamping the heat sink to a support structure beneath the first composite part;
applying an electromagnetic field to the first composite part under the heat sink to inductively weld the first composite part to a second composite part beneath the first composite part to form a thermoplastic joint; and
flowing a heat control fluid through the heat sink and a number of secondary heat sinks to control a temperature of the first composite part during induction welding of the thermoplastic joint.

12. The method of claim 11, wherein flowing the heat control fluid through the heat sink and a number of secondary heat sinks comprises independently controlling at least one of a volume or a temperature of the heat control fluid flowing through each of the heat sink and the number of secondary heat sinks.

13. The method of claim 11 further comprising:
receiving dimensions of the thermoplastic joint; and
machining aluminum into the heat sink having a unitary footprint with a length equivalent to a length of the thermoplastic joint using the dimensions of the thermoplastic joint.

14. The method of claim 11, wherein the heat sink having a unitary footprint the same as a thermoplastic joint to be formed between the first composite part and a second composite part.

15. A temperature control system for induction welding comprising:
a heat sink formed of an electrically conductive metal having a unitary footprint of a thermoplastic joint and comprising a plurality of channels extending from a first end of the heat sink to a second end of the heat sink;
a fluid control system comprising a number of pumps, a heater, a chiller, and a number of valves; and
a number of secondary heat sinks, each secondary heat sink of the number of secondary heat sinks having a length the same as the unitary footprint of the heat sink, each secondary heat sink comprising a number of channels extending through the secondary heat sink.

16. The temperature control system of claim 15, wherein the number of secondary heat sinks have a smaller width than the unitary footprint.

17. The temperature control system of claim 15, wherein the plurality of channels in the heat sink run perpendicular to a longitudinal axis of the heat sink, and wherein the number of channels in each secondary heat sink runs parallel to a longitudinal axis of the secondary heat sink.

18. The temperature control system of claim 15, wherein the heat sink and the number of secondary heat sinks are formed of aluminum.

19. The temperature control system of claim 15, wherein the plurality of channels are parallel to a longitudinal axis of the heat sink.

20. The temperature control system of claim 15, wherein the plurality of channels are perpendicular to a longitudinal axis of the heat sink.

21. The temperature control system of claim 15, wherein the unitary footprint is configured to cover a surface of a composite part exposed to an electromagnetic field.
